(19) United States
(12) Patent Application Publication
(10) Pub. No.: US 2026/0071588 A1
(43) Pub. Date: Mar. 12, 2026

(54) Dual-Head Opposing-Piston Free-Piston Stirling Engine Design

(71) Applicant: Exowatt, Inc., Miami, FL (US)

(72) Inventors: Sushrut Bapat, Miami, FL (US); SeonYoung Kim, Miami, FL (US); Simon Shuham, Miami, FL (US); Neerav Abani, Miami, FL (US)

(21) Appl. No.: 19/323,702

(22) Filed: Sep. 9, 2025

Related U.S. Application Data
(60) Provisional application No. 63/692,661, filed on Sep. 9, 2024.

(51) Int. Cl. F02G 1/044

(52) U.S. Cl. CPC F02G 1/044; F02G 2244/12

(57) ABSTRACT

A thermal engine arrangement comprising a first thermal engine having a first free piston; a second thermal engine having a second free piston; wherein operations of the first and second thermal engines are synchronized to balance force the first thermal engine piston produces with opposing force the second thermal engine piston produces.

### CROSS-REFERENCE TO RELATED APPLICATIONS

This application claims benefit of U.S. Provisional Application No. 63/692,661 filed 09/09/2024.This application is related to commonly-assigned U.S. patent application Ser. No. 63/686,611 filed Aug. 23, 2024 and U.S. patent application Ser. No. 19/308,157 filed Aug. 22, 2025, entitled HOT-GAS FREE-PISTON STIRLING ENGINE WITH EFFICIENT HOT AIR INLET (Attorney Docket No. 8839-48). These applications are incorporated herein by reference in their entirety and for all purposes.

### FIELD

The technology herein relates to thermal engines, and in particular to piston-based thermal engines such as Stirling engines. Still more particularly, the technology herein relates to a free-piston Stirling engine design with dual-head opposing pistons.

### BACKGROUND & SUMMARY

We are all familiar with internal combustion piston engines that take in a fuel-air mixture and burn the mixture internally to produce hot expanding gases. The hot expanding gases apply force to move one or more power pistons to generate mechanical power. The hot gases are then expelled from the engine through an exhaust system—generating pollution such as smog.

There is another kind of piston engine called a thermal or heat engine that moves the piston based on hot expanding gas heated by externally-applied heat. Such a thermal or heat engine does not expel the hot gases but instead cools and recycles them without polluting the surrounding air.

One such type of thermal or heat engine is a “Stirling engine”—named after Robert Stirling who invented a thermodynamic closed cycle in the early 19th century as a potential alternative to steam engines. In a Stirling engine, a working fluid such as a gas is heated and expanded due to thermal energy supplied from outside the engine. The gas then flows to a different location within the engine where it is cooled and compressed. A piston (or pistons) moves the gas to the correct places within the engine, at the correct time in the cycle, and extracts mechanical power from it. The gas alternates between these heating and cooling cycles, changing temperature and pressure as it goes. A regenerator acts as a temporary heat store by retaining heat within the engine rather than dumping it into the environment, thereby increasing its efficiency. There are no intake and no exhaust gas flows so the engine is practically silent. See e.g., //en.wikipedia.org/wiki/Stirling_engine#Theory

A Stirling engine is a kind of heat engine operated by the cyclic compression and expansion of air or other gas (the working fluid) between different temperatures, resulting in a net conversion of heat energy to mechanical work. See e.g., Walker, “Stirling Engines” (Clarendon Press, Oxford 1980); W. R. Martini, “Stirling Engine Design Manual” (2d Ed. NASA 1983). The Stirling engine is a closed-cycle heat engine—meaning a thermodynamic system in which the working fluid is permanently contained within the system. As noted above, the Stirling engine's internal “regenerator” heat exchanger and thermal store retains heat from one cycle to the next.

While Stirling engines have in the past enjoyed only limited, specialized application, there is renewed interest in Stirling engines for use in or with renewable energy sources such as solar energy collection. See e.g., Kongtragool et al, “A review of solar-powered Stirling engines and low temperature differential Stirling engines” Renewable and Sustainable Energy Reviews Volume 7, Issue 2,, Pages 131-154 (April 2003); Singh, “Review on solar Stirling engine: Development and performance”, Thermal Science and Engineering Progress Volume 8, Pages 244-256 (December 2018); Taki et al, “A Study of Stirling Engine Efficiency Combined with Solar Energy”, Advances in Science, Technology and Engineering Systems Journal Vol. 6, No. 2, 837-845 (2021).

There are also a few commercial Stirling engine designs available in the market. The Microgen Engine Corporation (MEC) Free Piston Stirling engine (see e.g., U.S. Pat. No. 6,983,593 and www. microgen-engine. com/technology/) has a Stirling cycle efficiency listed at 26%. Frauscher Motors GmbH has a hot-air engine measured efficiency of 22%. See e.g., https://frauscher-motors.com/alphagamma-technology/.

Horizontally opposed internal combustion engine designs have long been known. For example, the Volkswagen Beetle and its more expensive Porsche cousins used horizontally opposed pistons to balance engine forces. Other multicylinder internal combustion engines such as the socalled “V6” or “V8” also balance engine (piston) forces through a crankshaft configuration with counterweights that moves pistons on opposite sides of the engine in a coordinated fashion, usually in a sequential firing order so the various pistons arrive at top dead center (TDC) at different times in sequence. Part of the engine balancing takes into account the combustion mini-explosions that occur in each combustion cylinder, making these mini-explosions occur in sequence in order to reduce overall engine vibration. Thus, internal combustion engines provide a different designs, problem sets and solutions.

There have been a few opposed thermal engine arrangements in the past, with a single thermal engine having opposed pistons. See for example Sun et al, Operating characteristics study of a dual-opposed free-piston Stirling generator, Applied Thermal Engineering Volume 249 15 Jul. 2024, 123387 //doi. org/10.1016/j.applthermaleng.2024.123387; Geng et al, Test Results From a Pair of 1-kWe Dual-Opposed Free-Piston Stirling Power Convertors Integrated With a Pumped NaK Loop, NASA™—2011-216266 (March 2011). However, further improvements and innovations are possible.

Higher capacity thermal, heat and Stirling engine designs are for example desired. In particular, such thermal engine designs that operate based on very high temperatures provided by hot gases produced by solar collection would fulfill a long felt but unsolved need.

### BRIEF DESCRIPTION OF THE DRAWINGS

FIG. 1 shows an example dual head thermal engine design.

FIG. 2 shows in cross-section an example thermal engine system including a hot gas inlet and associated heat exchanger thermally coupled to a thermal engine.

FIG. 3 shows a cutaway view of an example thermal engine with a finned hot gas inlet structure in place.

FIG. 3A shows an example hot air inlet with inlet manifold removed to expose internal fins.

FIG. 3B shows an example exploded view of the hot air inlet and the thermal engine.

FIG. 3C shows a detailed view of an example hot air inlet finned structure.

FIG. 4A shows the example thermal engine and example hot air inlet coupled together with see-through to internal parts/structures shown in cross-section.

FIG. 4B shows another exploded view of the thermal engine including hot air inlet from a perspective that is slightly rotated as compared to FIG. 3B.

FIG. 5 shows a cutaway view of the example thermal engine with the hot gas inlet removed.

FIG. 6 shows an outer view of a thermal engine.

FIGS. 7A & 7B show different views of an example thermal engine with its top casing in place but with the hot gas inlet removed.

FIGS. 8A, 8B, show different external views of an example thermal engine.

FIGS. 9A, 9B show different external views of an example thermal engine casing and form factor.

### DETAILED DESCRIPTION OF NON-LIMITING EMBODIMENTS

Free-Piston Stirling Engines (FPSEs) have an unbalance force due to their nature of single power piston arrangement. The forces become excessive after 2 kW of engine power. The proposed arrangement addresses this problem and provides a for example 5 to 6 kW FPSE

An example embodiment provides a 5 to 6 kW FPSE Stirling engine design.

The solution provides two smaller FPSEs arranged to cancel out the unbalance forces provided by the (each) piston. The arrangement also allows to achieve sufficient heat transfer area that will be necessary to absorb large amounts, for example,15 kW, of thermal energy.

Advantages: Opposing Piston, High-power well balanced FPSE

### EXAMPLE

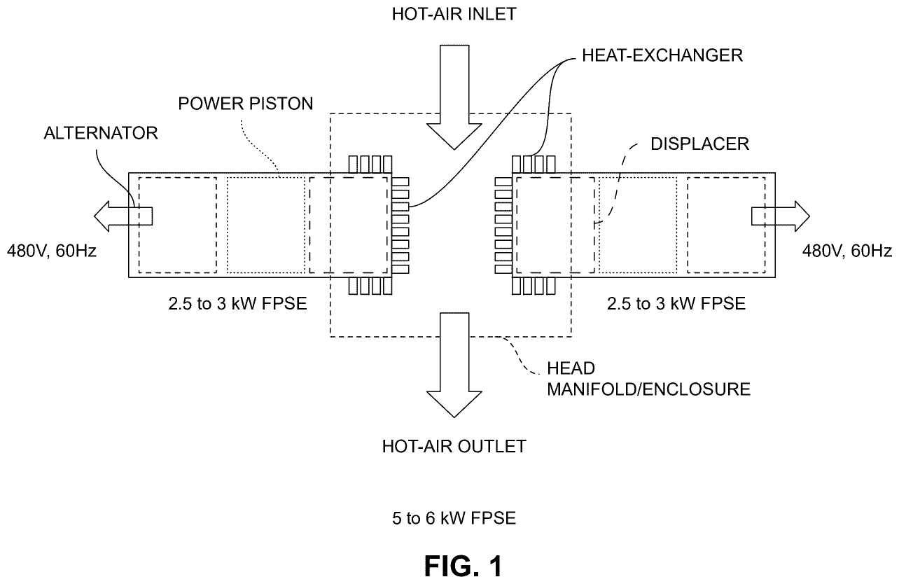

FIG. 1 shows an example design including a pair of opposed free-piston Stirling engines. In this example, each engine operates independently, and their operations are synchronized to balance forces between them.

### Example Thermal Engine Design

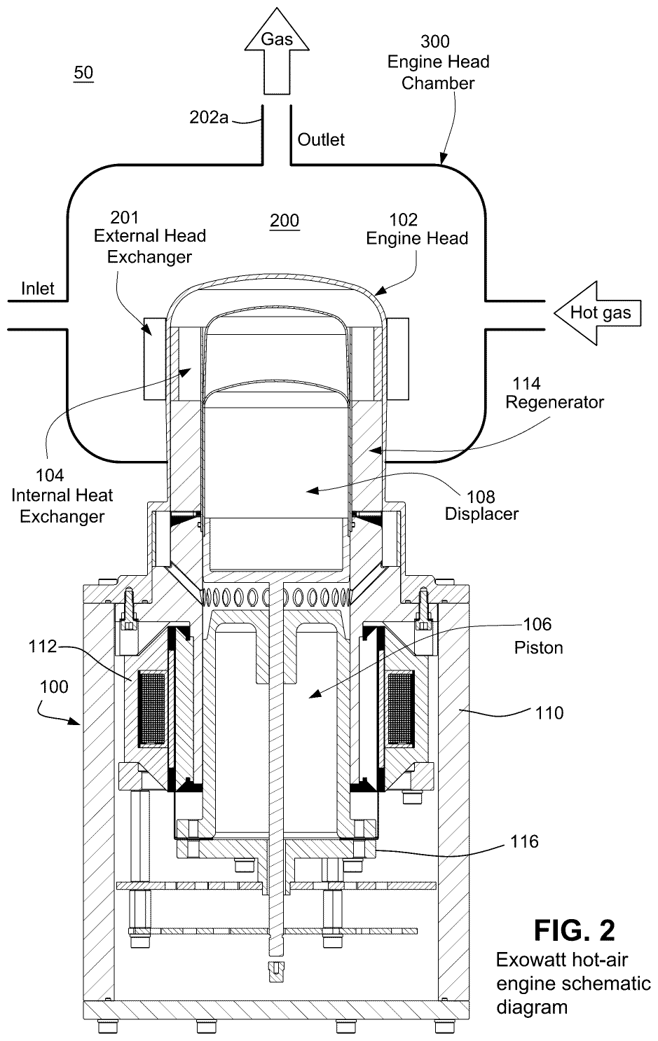

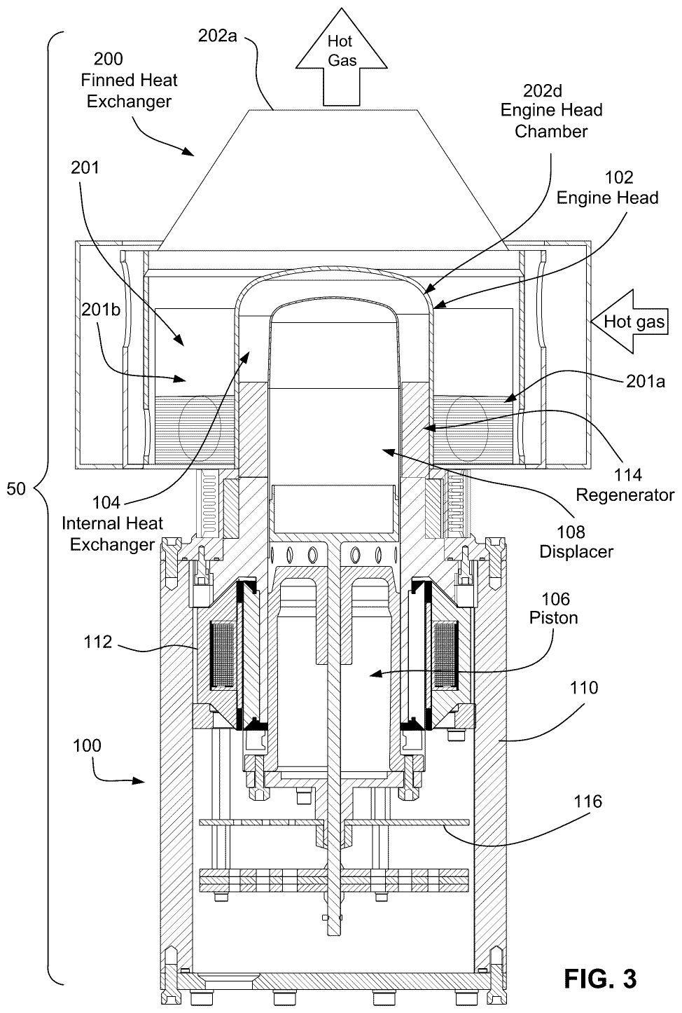

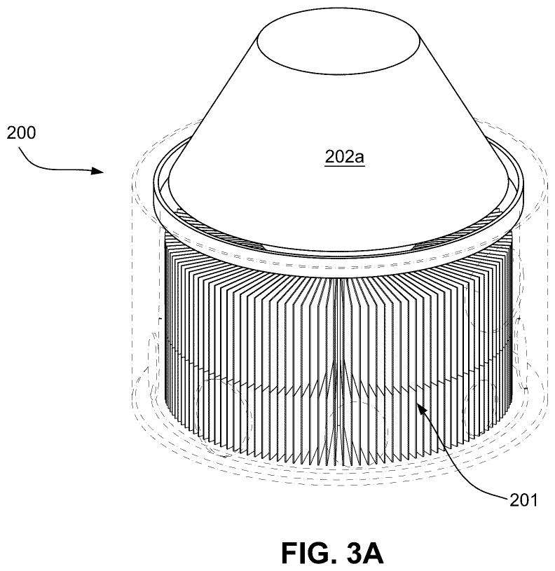

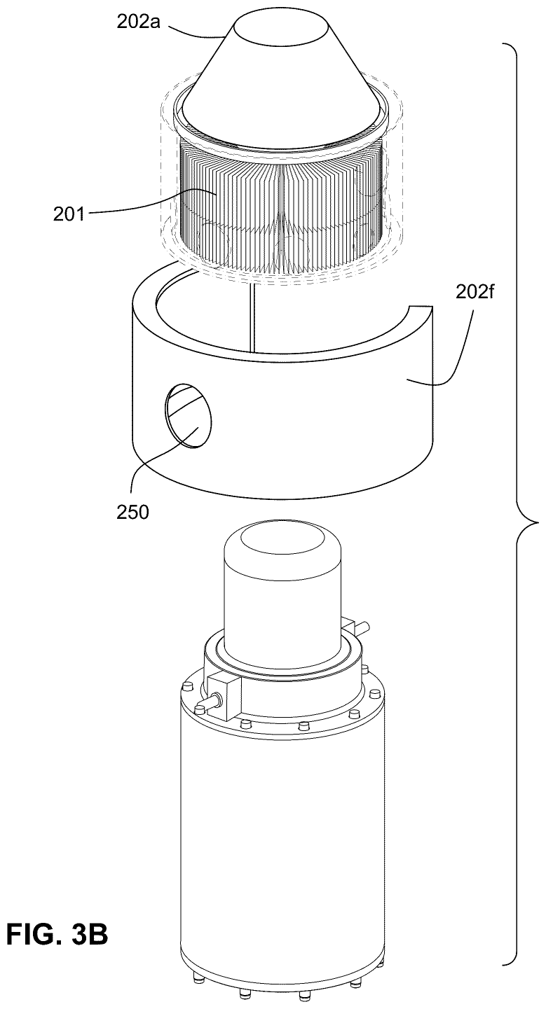

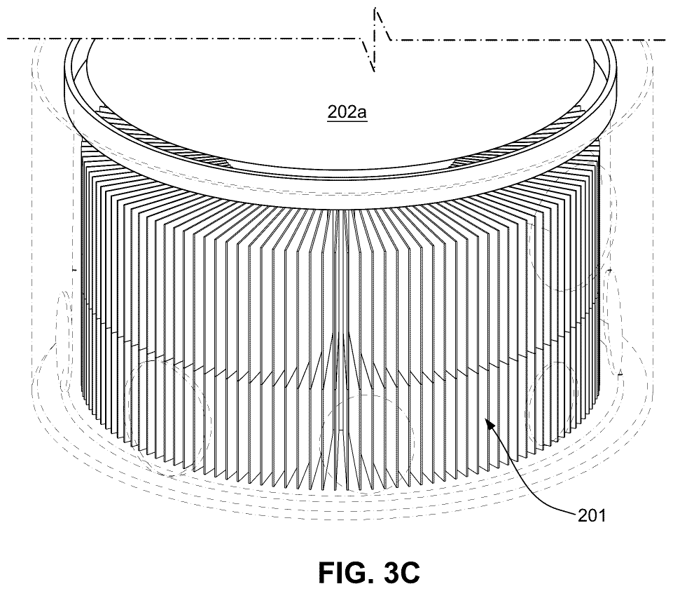

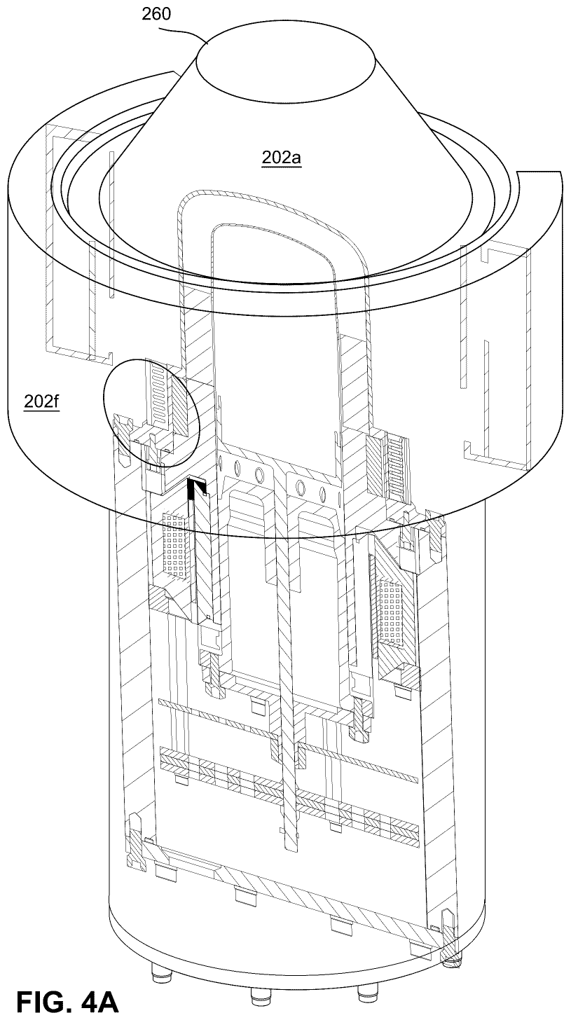

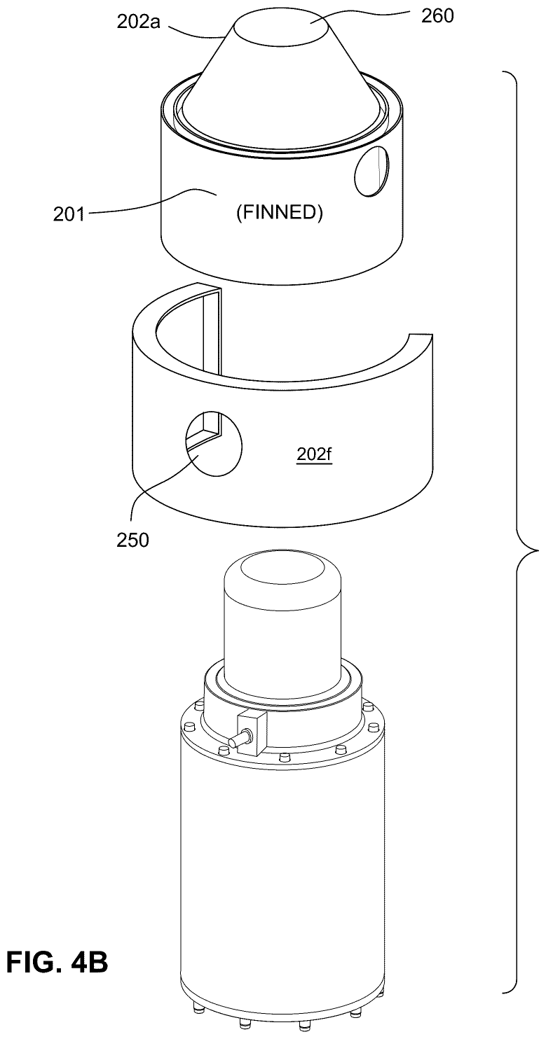

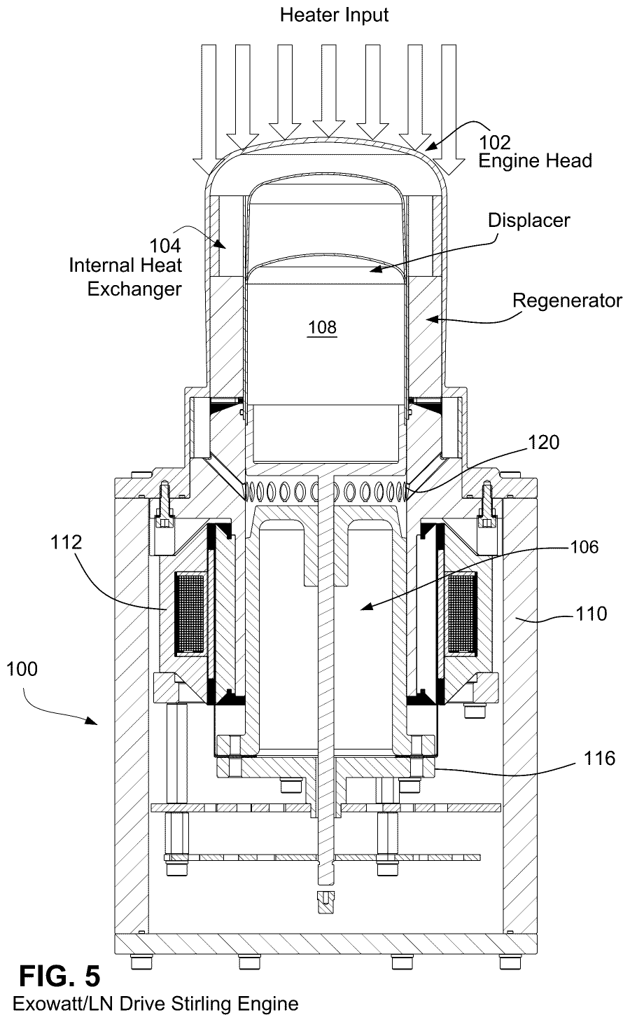

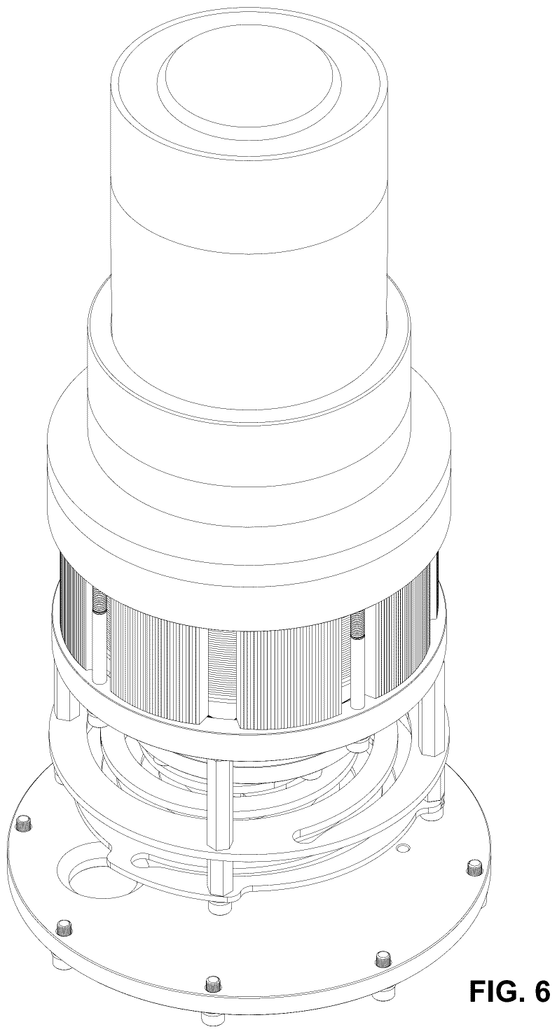

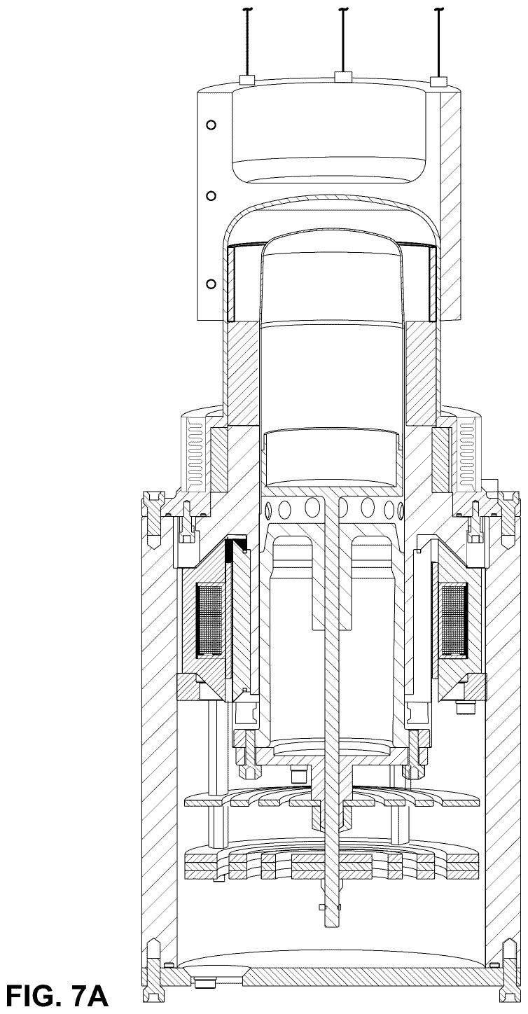

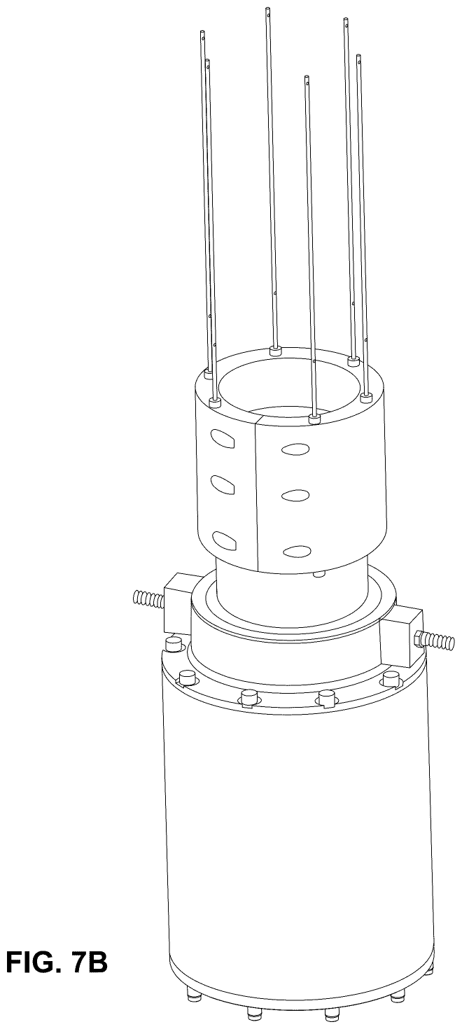

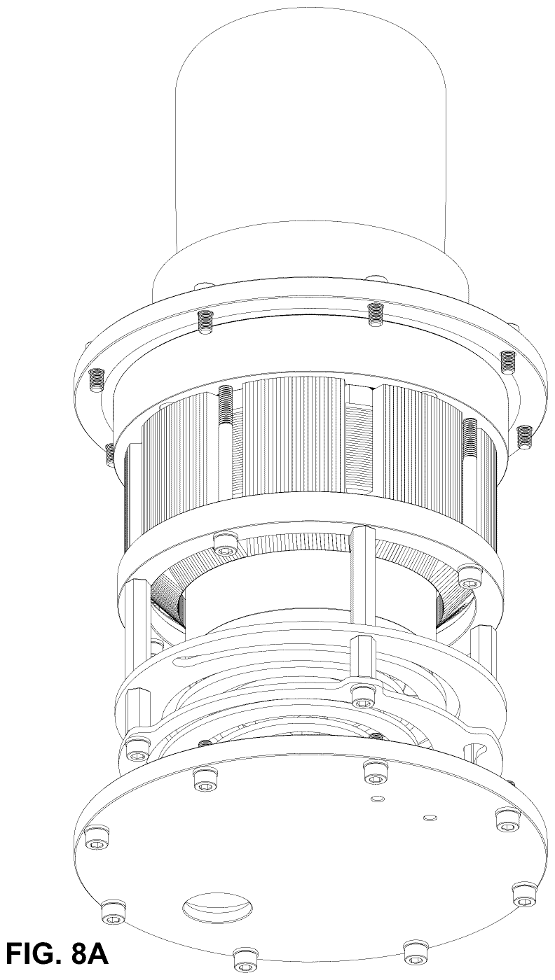

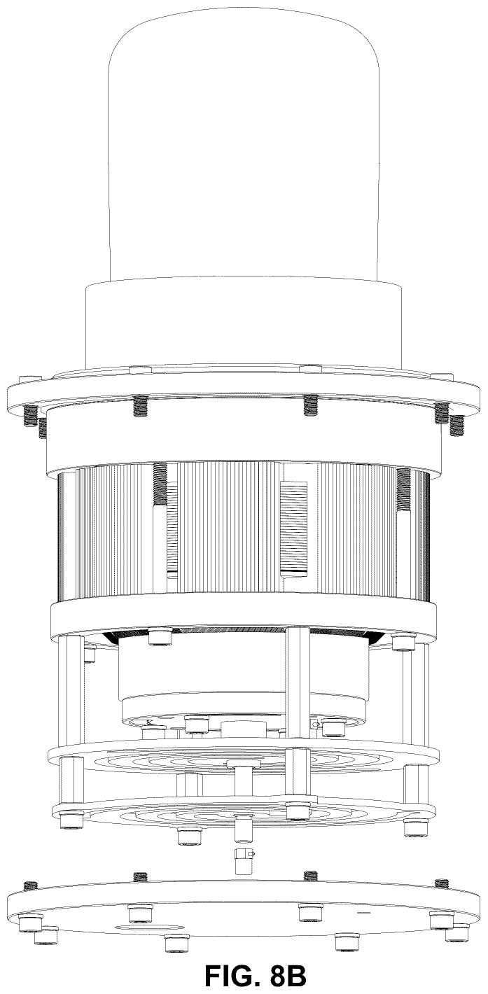

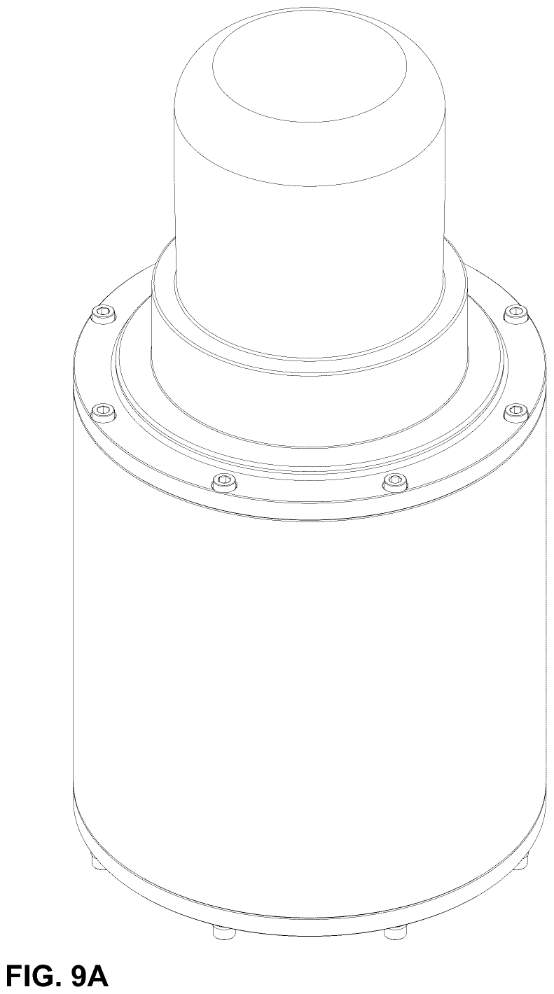

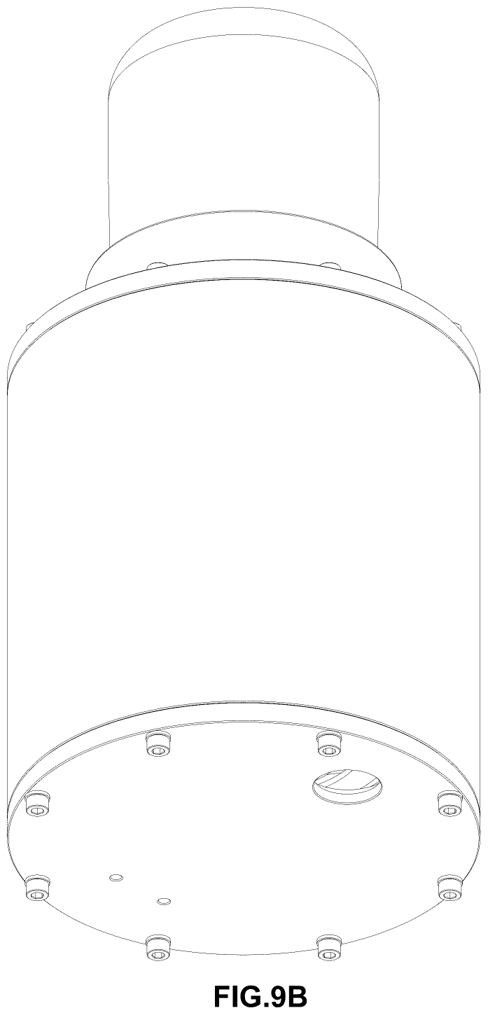

The lefthand side engine and righthand side engine in example embodiments can be identical in structure and operation. For example, each engine may be structured as described in U.S. patent application Ser. No. 63/686,611 filed Aug. 23, 2024 and U.S. patent application Ser. No. 19/308,157 filed Aug. 22, 2025, entitled HOT-GAS FREE-PISTON STIRLING ENGINE WITH EFFICIENT HOT AIR INLET (Attorney Docket No. 8839-48), each of which is incorporated herein by reference and expressly included as part of the present filing. Thus, each engine shown in FIG. 1 may comprise a free-piston Stirling engine 100 such as shown in FIGS. 2-4B with helium as a working fluid but can be hydrogen, air or any other gas or combination of gases. The engine head 102 (which may comprise stainless steel) accepts heat from the hot gas inlet 200 and delivers the heat to the working fluid within the engine using an internal heat exchanger 104 which forms a domed engine head chamber 300 within the engine. The working fluid increases its temperature and subsequently its pressure. It then expands isothermally to drive a power piston 106 outward, thereby creating mechanical energy. This mechanical energy can move magnets or electromagnets relative to coils to produce electricity.

In one example, each engine has a displacer 108 positioned between a power piston 106 and a domed chamber 300. In this example embodiment, each Stirling engine is a β type and the displacer 108 and the piston 106 share the same cylinder. The displacer 108 reciprocates in the example shown to displace the helium or other working fluid from the hot end (inner) of the cylinder to the cold end (outer) and vice versa. The role of the displacer 108 is to move, or displace, working fluid in the engine between a heated region and the cooled region. In the example shown, the piston 106 and the displacer 108 are linked together such that their movements are 90 degrees out of phase. That is, when the power piston 106 is either at its maximum or minimum height and moving slowly, the displacer 108 is at its halfway point and moving at its maximum speed.

When displacer 108 is in the lower cold region, this forces the working gas to occupy the upper hot region. The internal heat exchanger 104 adds heat to the gas and the gas—expands—forcing the power piston 106 to move downwards.

The power piston 106 moves more slowly when it is at its outermost position (the heated gas has its maximum volume). The displacer 108, on the other hand, is moving inward into the hot region causing the gas to move from the upper hot region to the lower cold region. In this design, a regenerator 114 is disposed around the displacer 108. Regenerator 114 stores heat from one cycle so it can be used in the next cycle. The regenerator 114 is made of a material that can withstand high temperatures that are coupled to the engine 100. Thus, when the displacer 108 is moving upwards to move the working fluid from the hot region to the cold region, the working fluid flows past the regenerator 114 and gives up some of its heat to the regenerator so the regenerator temporarily stores energy taken from the gas as it cools. One skilled in the art understands that the temperature differential between the working fluid in the hot region and the working fluid in the cold region is instrumental to making the Stirling engine function and function efficiently. To this purpose, the engine 100 contains a cold end heat exchanger 120 that maintains the cold end at some desired temperature such as for example 60 deg C.

Once most or all of the gas is in the cold region, it contracts (heat has been removed from the gas) causing the power piston 106 to begin to move inwards (a spring arrangement 116 also causes the piston to move upwards after being forced inward by the hot expanded working fluid to its innermost position). A unique shape of the spring 116 and dimensions provide a piston 106 with the spring back force.

The power piston 106 moves more slowly as it nears a maximum outward position to define a minimum volume within the cylinder. The displacer 108 is meanwhile moving inwards, forcing the gas to move from the cold region into the hot region. As the cool gas passes by the regenerator 114, the gas recovers some of the heat that was temporarily stored in the regenerator. The gas now in the upper hot region absorbs more heat from the internal heat exchanger 104. The state of the Stirling engine 100 has thus returned to its initial described state. The Stirling cycle repeats indefinitely.

In one embodiment, each engine 100 contains a linear alternator 112—an electromechanical component that converts the oscillating motion of the piston 106 to electrical energy. In other embodiments, an electrical, electromechanical or mechanical component(s) can be mechanically coupled to a piston rod to move with the piston 106.

Each engine design contains a gas seal that is formed by a network of micro-groves. The gas seal eliminates need for piston rings that need oil for lubrication. The gas seal performs the function of the lubricant and the sealant and therefore reduces complexity and maintenance burden.

In one embodiment, a cylinder liner is used to protect the displacer 108 and seal the piston 106. In one embodiment, the gas seal maintains a pressure of e.g., 500 PSI within the cylinder so the working fluid does not escape.

### Balancing the Forces

A single engine will produce unbalanced forces, which can reduce the lifetime of the engine and increase maintenance and repair costs. To solve this problem, the FIG. 1 example provides an arrangement of two opposing, independent thermal engines with associated opposed free pistons. A common heat source can be used to supply heat to both of the opposing Stirling engines. The common heat source can supply heated working fluid into a common enclosure that is thermally coupled to heat exchangers of both opposing Stirling engines.

The two Stirling engines are controlled to operate synchronously so leftward movement of the left engine piston is synchronized with rightward movement of the right engine piston. In other words, in one embodiment, as the leftward piston moves outward to the left, the rightward piston moves outward to the right. The leftward force of the left engine piston is thus balanced with rightward force of the right engine piston such that the two forces cancel or substantially cancel one another to result in a net zero force. Additionally, the center of gravity of the arrangement stays relatively constant because leftward distance-from-center of the leftward piston balances rightward distance-from-center of the rightward piston.

In this embodiment, both pistons toward each other at the same time as well. Hence, when the left engine piston moves to the right, the right engine piston moves to the left, once again producing balanced forces that cancel or substantially cancel one another to result in a net zero force.

While the embodiment shown has horizontally opposed cylinders and pistons, other orientations are possible. For example, the engine could be oriented vertically rather than horizontally, or the pistons and cylinders of the two engines might not be coaxial but might instead be offset from one another such as in a “V”.

A 5-6 kilowatt design requires a lot of heat to operate. Because the heat exchange area of a Stirling engine is typically relatively small, it is typically difficult to get a Stirling engine to work at such high power levels. In the FIG. 1 design shown, in contrast, each of the two engines can be made smaller (e.g., some fraction such as half of the total designed power output). Furthermore, the heat exchange areas of each of the two engines can be made sufficiently large to operate each engine at a design output power which when combined with the output power of the other opposed engine will result in the desired total power output.

The design shown is not limiting as to the number of engine pairs. For example, another design could have four opposed Stirling engines (two pairs of two opposed engines) arranged on a N-S-E-W (north-south-east-west) cross-like axis system, so the N top and S bottom engines balance one another and W left and E right engines balance one another). Other designs can have 2N opposed engines where N is any integer.

### Manufacturing Integrated Unit Example

In an example embodiment, an integrated unit is manufacturable with 3D printing wherein a heat exchanger (internal and/or external) and the cylinder head in the above design are one integrated unit. Although in mass manufacturing 3D printing can be expensive, there is a benefit to going to an integral unit of heat exchanger and head. This integrated arrangement improves heat exchange through the engine, as the contact resistance using the same material will help with expansion of parts. Specifically, since the integrated design for both the heat exchanger and the cylinder head are made out of the same material, they will each have the same coefficient of expansion and will therefore expand and contract by the same amount when subjected to temperature changes. 3D printing of the integrated until removes any contact resistance as there is no need of brazing or pressure fitting the two components.

All patents and publications cited herein are incorporated by reference as if expressly set forth

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A thermal engine arrangement comprising:
a first thermal engine free piston;
a second thermal engine free piston;
wherein operations of the first and second thermal engine free pistons are synchronized to balance force the first thermal engine free piston exerts with opposing force the second thermal engine free piston exerts.

2. The thermal engine arrangement of claim 1 wherein the first thermal engine free piston is part of a first thermal engine, and the second thermal engine free piston is part of a second thermal engine different and independent from the first thermal engine.

3. The thermal engine arrangement of claim 2 wherein:
the first thermal engine comprises:
a first internal cylindrical cavity, the first thermal engine free piston being reciprocally-movable within the first internal cylindrical cavity according to the Stirling principle,
a first thermal head;
a first spring connected to the first piston, the first spring storing and providing energy for continual reciprocation of the first thermal engine free piston; and
a first heat exchanger thermally coupled to the first thermal head, the first heat exchanger configured to receive a flow of first working fluid originating externally to the first thermal engine and to transfer heat from the first working fluid flow to the first thermal head and thereby to third working fluid within the first internal cylindrical cavity, to thereby cause the first piston to reciprocate within the first internal cylindrical cavity according to the Stirling principle; and
the second thermal engine comprises:
a second internal cylindrical cavity, the second thermal engine free piston being reciprocally-movable within the second internal cylindrical cavity according to the Stirling principle,
a second thermal head;
a second spring connected to the second piston, the second spring storing and providing energy for continual reciprocation of the second thermal engine free piston; and
a second heat exchanger thermally coupled to the second thermal head, the second heat exchanger configured to receive a flow of second working fluid originating externally to the second thermal engine and to transfer heat from the second working fluid flow to the second thermal head and thereby to fourth working fluid within the second internal cylindrical cavity, to thereby cause the second piston to reciprocate within the second internal cylindrical cavity according to the Stirling principle.

4. The thermal engine arrangement of claim 3 wherein the first piston has disposed thereon a gas seal formed by a network of micro-grooves disposed on an outer cylindrical surface of the first piston adjacent to a crown of the first piston, the network of micro-grooves lubricating and sealing the first piston outer cylindrical surface to the first internal cylindrical cavity without requiring any sealing piston ring.

5. The thermal engine arrangement of claim 3 further comprising a regenerator surrounding a portion of the first internal cylindrical cavity.

6. The thermal engine arrangement of claim 3 wherein the first internal cylindrical cavity terminates in the first thermal head comprising a dome-shaped structured enclosing an end of the first internal cylindrical cavity.

7. The thermal engine arrangement of claim 3 further comprising a displacer disposed within the first internal cylindrical cavity, the displacer being mechanically coupled to move in response to reciprocation of the first piston.

8. The thermal engine arrangement of claim 3 further including a linear generator element connected to the first piston, the linear generator element converting linear piston reciprocation to electrical current.

9. The thermal engine arrangement of claim 3 wherein the first thermal engine comprises a cylindrical capped structure and the first heat exchanger is removably disposed onto the thermal head cylindrical capped structure.

10. The thermal engine arrangement of claim 9 wherein the heat exchanger comprises a plurality of coaxial, concentric heat exchange fins integrated with the thermal head cylindrical capped structure such that no brazing or pressure fitting is needed.

11. The thermal engine arrangement of claim 1 wherein a first displacer and the first piston coaxially reciprocate, and a second displacer and the second piston coaxially reciprocate.

12. A thermal engine arrangement comprising:
a first thermal engine including a first free piston;
a second thermal engine including a second free piston;
wherein the operations of the first free piston and second free piston are synchronized to balance force the first free piston exerts with opposing force the second free piston exerts.

13. The thermal engine arrangement of claim 12 wherein:
the first thermal engine comprises:
a first internal cylindrical cavity, the first free piston being reciprocally-movable within the first internal cylindrical cavity according to the Stirling principle,
a first thermal head;
a first spring connected to the first free piston, the first spring storing and providing energy for continual reciprocation of the first free piston; and
a first heat exchanger thermally coupled to the first thermal head, the first heat exchanger configured to receive a flow of first working fluid originating externally to the first thermal engine and to transfer heat from the first working fluid flow to the first thermal head and thereby to third working fluid within the first internal cylindrical cavity, to thereby cause the first free piston to reciprocate within the first internal cylindrical cavity according to the Stirling principle; and
the second thermal engine comprises:
a second internal cylindrical cavity, the second free piston being reciprocally-movable within the second internal cylindrical cavity according to the Stirling principle,
a second thermal head;
a second spring connected to the second free piston, the second spring storing and providing energy for continual reciprocation of the second free piston; and
a second heat exchanger thermally coupled to the second thermal head, the second heat exchanger configured to receive a flow of second working fluid originating externally to the second thermal engine and to transfer heat from the second working fluid flow to the second thermal head and thereby to fourth working fluid within the second internal cylindrical cavity, to thereby cause the second free piston to reciprocate within the second internal cylindrical cavity according to the Stirling principle.

14. The thermal engine arrangement of claim 13 wherein the first free piston has disposed thereon a gas seal formed by a network of micro-grooves disposed on an outer cylindrical surface of the first free piston adjacent to a crown of the first free piston, the network of micro-grooves lubricating and sealing the first free piston outer cylindrical surface to the first internal cylindrical cavity without requiring any sealing piston ring.

15. The thermal engine arrangement of claim 13 further comprising a regenerator surrounding a portion of the first internal cylindrical cavity.

16. The thermal engine arrangement of claim 13 wherein the first internal cylindrical cavity terminates in the first thermal head comprising a dome-shaped structured enclosing an end of the first internal cylindrical cavity.

17. The thermal engine arrangement of claim 13 further comprising a displacer disposed within the first internal cylindrical cavity, the displacer being mechanically coupled to move in response to reciprocation of the first free piston.

18. The thermal engine arrangement of claim 13 further including a linear generator element connected to the first free piston, the linear generator elements converting linear piston reciprocation to electrical current.

19. The thermal engine arrangement of claim 13 wherein the first thermal engine further comprises a cylindrical capped structure and the first heat exchanger is removably disposed onto the thermal head cylindrical capped structure.

20. The thermal engine arrangement of claim 19 wherein the first heat exchanger comprises a plurality of coaxial, concentric heat exchange fins.
